(19) United States
(12) Patent Application Publication
(10) Pub. No.: US 2006/0079594 A1
(43) Pub. Date: Apr. 13, 2006

(54) Process for preparing graft copolymer membranes

(76) Inventor: Charles Stone, West Vancouver (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/195,355

(22) Filed: Aug. 2, 2005

Related U.S. Application Data
(63) Continuation of application No. 10/392,624, filed on Mar. 20, 2003, now abandoned.
Application No. 10/392,624 is a continuation-in-part of application No. 10/229,380, filed on Aug. 27, 2002, now abandoned.
(60) Provisional application No. 60/386,205, filed on Aug. 27, 2001.
(60) Provisional application No. 60/395,517, filed on Jul. 12, 2002.

(51) Int. Cl. B29D 11/00; C08J 3/28

(52) U.S. Cl. 522/85; 522/124

(57) ABSTRACT

A process for preparing a graft copolymer membrane is provided comprising exposing a polymeric base film to a dose of ionizing radiation, and then contacting the irradiated base film with an emulsion comprising a fluorostyrenic monomer.

### CROSS-REFERENCES TO RELATED APPLICATIONS

This application is a continuation of U.S. patent application Ser. No. 10/392,624, filed Mar. 20, 2003, now pending; which is a continuation-in-part of U.S. patent application Ser. No. 10/229,380, filed Aug. 27, 2002, now abandoned; which application claims the benefit of U.S. Provisional Patent Application No. 60/386,205 filed Aug. 27, 2001, and U.S. Provisional Patent Application No. 60/395,517 filed Jul. 12, 2002; where these applications are incorporated herein by reference in their entireties.

### BACKGROUND OF THE INVENTION

1. Field of the Invention

The present invention relates to processes for preparing graft copolymer membranes by radiation induced graft polymerization of fluorostyrenic monomers, employing monomer emulsions.

2. Description of the Prior Art

The preparation of graft polymeric membranes by radiation induced graft polymerization of a monomer to a polymeric base film has been demonstrated for various combinations of monomers and base films. The grafting of styrene to a polymeric base film, and subsequent sulfonation of the grafted polystyrene chains has been used to prepare ion-exchange membranes.

U.S. Pat. No. 4,012,303 reports the radiation induced graft polymerization of α,β,β-trifluorostyrene (TFS) to polymeric base films using gamma ray co-irradiation. The graft polymerization procedure may use TFS in bulk or in solution. The '303 patent reports that aromatic compounds or halogenated compounds are suitable solvents.

U.S. Pat. No. 4,605,685 reports the graft polymerization of TFS to pre-irradiated polymeric base films. Solid or porous polymeric base films, such as for example polyethylene and polytetrafluoroethylene, are pre-irradiated and then contacted with TFS neat or dissolved in a solvent.

U.S. Pat. No. 6,225,368 reports graft polymerization of unsaturated monomers to pre-irradiated polymeric base films employing an emulsion including the monomer, and emulsifier and water. In the method of the '368 patent, a base polymer is activated by irradiation, quenched so as to affect cross-linking of the polymer, and then activated again by irradiation. The activated, cross-linked polymer is then contacted with the emulsion. The '368 patent also states that the use of the disclosed method eliminates homopolymerization caused by irradiation of the monomer, and that this allows the use of high concentrations of monomers in the emulsion.

These methods of preparing graft polymeric membranes have several disadvantages.

With co-irradiation, since the TFS monomer is simultaneously irradiated, undesirable processes such as monomer dimerization and/or independent homopolymerization of the monomer may occur in competition with the desired graft polymerization reaction.

When neat TFS is employed in graft polymerization reactions, it can be difficult to achieve a contact time between the monomer and the irradiated base film that would be suitable for high-volume production. Typically, the neat monomer does not wet the surface of the base film very effectively, and this can result in an undesirably low graft polymerization rate unless a prolonged contact time is employed. Further, the use of neat TFS may adversely increase the cost of the graft polymerization process, due to the excess of monomer that is required.

A disadvantage of graft polymerization reactions carried out using TFS solutions is the level of graft polymerization drops significantly as the concentration of monomer in the solution is lowered. Indeed, the '303 patent reports a significant decrease in percentage graft with decreasing TFS concentrations. The drop in percentage graft may be mitigated by increasing the radiation dosage and/or the grafting reaction temperature, but this necessarily increases the energy requirements of the graft polymerization process. Overall, the use of TFS in solution tends to undesirably increase the cost of the graft polymerization process.

Cross-linking the base polymer by irradiating and quenching it prior to grafting necessitates two separate irradiation steps. Quenching further involves heating the irradiated polymer and/or the addition of cross-linking agents. An obvious disadvantage to this process is that these steps add time and expense to the process and complicate the overall preparation of the graft polymeric membranes.

### BRIEF SUMMARY OF THE INVENTION

A process for preparing a graft copolymer membrane is provided comprising exposing a polymeric base film to a dose of ionizing radiation, and then contacting the irradiated base film with an emulsion comprising a fluorostyrenic monomer.

In one embodiment, the present process for preparing a graft copolymer membrane comprises:

exposing a polymeric base film to a dose of ionizing radiation; and

contacting the irradiated base film with an emulsion comprising at least one fluorostyrenic monomer,

wherein the amount of monomer in the emulsion is less than or equal to 30% by volume.

In another embodiment, the present process for preparing a graft copolymer membrane comprises exposing a polymeric base film to a dose of ionizing radiation, and contacting the irradiated base film with an emulsion comprising at least one substituted α,β,β-trifluorostyrene monomer.

In another embodiment, the present process for preparing a graft copolymer membrane comprises exposing a polymeric base film to a dose of ionizing radiation, and contacting the polymeric base film with an emulsion comprising trifluoronaphthyl monomers.

### BRIEF DESCRIPTION OF THE DRAWING

FIG. 1 is a schematic representation of an embodiment of the present process.

### DETAILED DESCRIPTION OF THE INVENTION

In the present process, a graft copolymer membrane is prepared by exposing a polymeric base film to a dose of ionizing radiation, and then contacting the irradiated base film with an emulsion comprising a fluorostyrenic monomer.

Any radiation capable of introducing sufficient concentrations of free radical sites on and within the polymeric base film may be used in the preparation of the graft copolymer membranes described herein. For example, the irradiation may be by gamma rays, X-rays, electron beam, or high-energy UV radiation. The base film may be irradiated in an inert atmosphere. The radiation dose to which the base film is exposed may vary from 1-100 Mrad. Typically, the dose range is between 20-60 Mrad.

The polymeric base film may be dense or porous. Typically, the base film imparts mechanical strength to the membrane and should be physically and chemically stable to irradiation and the conditions to which it is to be exposed in the end-use application of the graft copolymer membrane. Suitable base films include homopolymers or copolymers of non-fluorinated, fluorinated and perfluorinated vinyl monomers. Fluorinated and perfluorinated polymers may be desired for certain applications due to their enhanced oxidative and thermal stability. Suitable base films include, but are not limited to, films comprising polyethylene, polypropylene, polyvinylidene fluoride, polytetrafluoroethylene, poly(ethylene-co-tetrafluoroethylene), poly(tetrafluoroethylene-co-perfluorovinylether), poly(tetrafluoroethylene-co-hexafluoropropylene), poly(vinylidene fluoride-co-hexafluoropropylene), poly(vinylidene fluoride-co-chlorotrifluoroethylene), and poly(ethylene-co-chlorotrifluoroethylene).

The irradiated base film is then contacted with the emulsion and monomer is then incorporated into the base film to form a graft copolymer. The irradiated base film may be contacted with the emulsion in an inert atmosphere, if desired. The emulsion may assist in wetting the irradiated base film with the monomer.

Suitable fluorostyrenic monomers include α-fluorostyrenes, α,β-difluorostyrenes, α,β,β-trifluorostyrenes, and the corresponding fluoronaphthylenes. Unsubstituted and substituted monomers, particularly para-substituted monomers, may be employed. Mixtures of fluorostyrenic monomers may also be employed in the emulsion, if desired.

As used herein and in the appended claims, a substituted fluorostyrenic monomer refers to monomers having substituents on the aromatic ring. Suitable substituted α,β,β-trifluorostyrenes and α,β,β-trifluoronaphthylenes are described in PCT Application No. PCT/CA98/01041, and PCT Application No. PCT/CA00/00337. Examples of such α,β,β-trifluorostyrenes include, but are not limited to, methyl-α,β,β-trifluorostyrene, methoxy-α,β,β-trifluorostyrene, thiomethyl-α,β,β-trifluorostyrene, and phenyl-α,β,β-trifluorostyrene.

The emulsion may further comprise other suitable non-fluorinated monomers, such as styrene, α-methylstyrene, and vinyl phosphonic acid, for example. Depending on the end-use application of the graft copolymer membrane, the incorporation of a proportion of such non-fluorinated monomers may reduce the cost of the membrane without unduly affecting performance.

The emulsion may be an aqueous system, i.e., an emulsion comprising the monomer(s) and water. Alternatively, a non-aqueous emulsion may be employed, comprising the monomer(s) and an immiscible solvent. The solvent may be selected so as to facilitate swelling of the base film. As a further alternative, an aqueous emulsion may be used that also includes a solvent that facilitates swelling of the base film.

The emulsion may further comprise an emulsifier. Ionic and nonionic emulsifiers may be employed. Non-limiting examples of suitable ionic emulsifiers include sodium lauryl sulfate and dodecylamine hydrochloride; suitable nonionic emulsifiers include polyoxyethylene emulsifiers, such as Triton® X-100 (Rohm & Haas, Philadelphia, Pa.; an alkylphenolhydroxypolyoxyethlene). Depending upon the type and concentration of monomer(s) employed in the emulsion, an emulsifier may increase the stability of the emulsion. The particular emulsifier, if it is employed, is not essential and persons skilled in the art can readily choose a suitable emulsifier for a given application.

If desired, the emulsion may also comprise an inhibitor to limit the amount of dimerization and/or homopolymerization of the monomer(s) that may occur in the emulsion during graft polymerization. Again, the choice of inhibitor is not essential to the present process and suitable inhibitors will be apparent to persons skilled in the art.

The graft polymerization reaction may be carried out at any suitable temperature. Higher temperatures may result in higher graft polymerization rates, but can also increase the rate of dimerization/homopolymerization of the monomer. Suitable temperature ranges will depend on such factors as the desired level of grafting of the base film, the graft polymerization rate as a function of temperature for the monomer(s) employed, and the rate of dimerization/homopolymerization of the monomer(s) as a function of temperature. For example, temperatures in the range of 20-100° C. are suitable, with a range of 50-80° C. being typical when employing α,β,β-trifluorostyrenic monomers. Persons skilled in the art can readily determine suitable temperature ranges for a given application of the present process.

The method by which the irradiated base film is contacted with the emulsion is not essential to the present process. For example, the irradiated base film may be soaked or dipped in an emulsion bath, or the emulsion could be coated as a layer onto the irradiated base film. Alternatively, the emulsion could be sprayed on, either as an emulsion or as components that form the emulsion in situ. As a further example, the emulsion could be contacted with the irradiated base film as a mist. A combination of any of the foregoing methods may also be employed.

After graft polymerization, the graft copolymer membrane may be washed in a suitable solvent. The choice of solvent is not essential to the present process. Generally, it should be a solvent for the monomer but not for the base film. Persons skilled in the art can readily determine suitable solvents for a particular application.

Ion exchange functionality may then be introduced (directly or indirectly) into the graft copolymer membrane by subsequent reactions, such as, halomethylation, sulfonation, phosphonation, amination, carboxylation, hydroxylation (optionally combined with subsequent phosphorylation) and nitration, for example, to produce an ion exchange membrane suitable for various applications. More than one ion exchange moiety may be introduced into the graft copolymer membrane. Sulfonation or phosphonation, in particular, may be employed where the graft copolymer membrane is intended as an ion exchange membrane for use in fuel cell applications.

The particular method of introducing ion exchange functionality into the grafted film is not essential to the present process, nor is the selection of the particular reagent. For example, where a sulfonated graft copolymer membrane is desired, liquid or vapor phase sulfonation may be employed, using sulfonating agents such as sulfur trioxide, chlorosulfonic acid (neat or in solution), and oleum; with chlorosulfonic acid a subsequent hydrolysis step may be required.

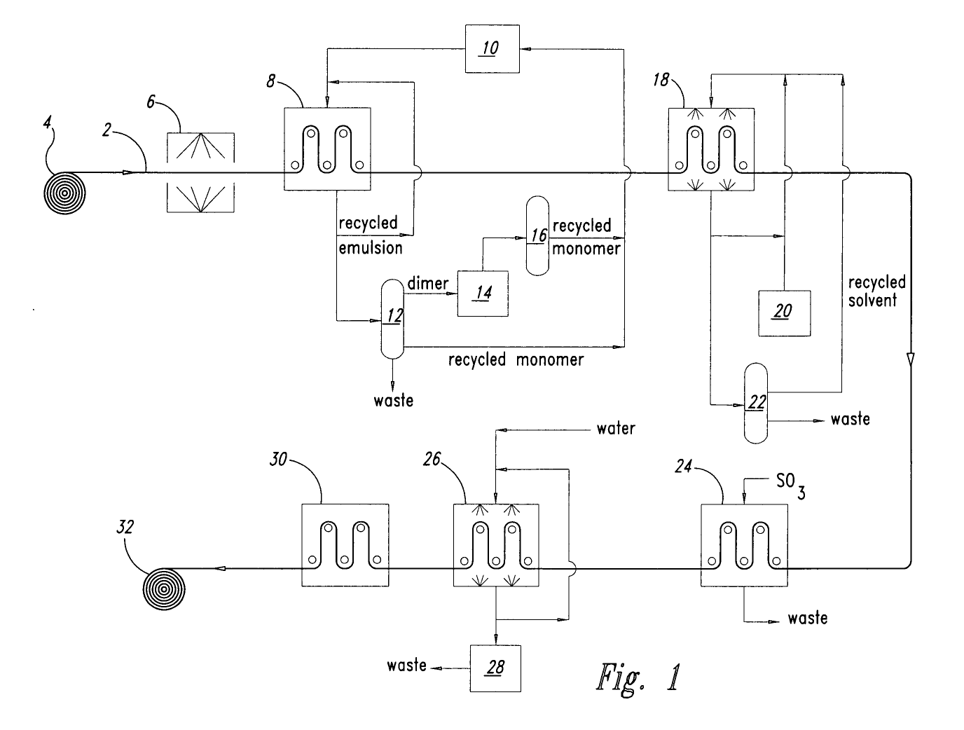

FIG. 1 is a schematic representation of an embodiment of the present process. For the purpose of illustration, graft polymerization and sulfonation of a dense polymeric base film is described. Polymeric base film 2 is fed from roller station 4 to irradiation chamber 6, where it is exposed to a dose of ionizing radiation in an inert atmosphere. The irradiated base film then moves to grafting chamber 8 where it is exposed to an emulsion comprising a fluorostyrenic monomer. The monomer is then incorporated into the base film to form a graft copolymer.

The emulsion is formed in supply 10 and supplied to grafting chamber 8. Excess emulsion may then be recycled to grafting chamber 8, as illustrated. As mentioned previously, the monomer(s) may dimerize instead of forming a graft copolymer with the irradiated base film. When the concentration of dimer in the emulsion increases, the excess emulsion may be directed to separator 12, which separates monomer and dimer present in the emulsion. The recycled monomer may then be directed to supply 10 for re-use in the emulsion. Dimer is directed to storage vessel 14. Once a sufficient amount of dimer is present in storage vessel 14, it is then directed to reactor 16 where it is cracked to form monomer, which may then be directed to supply 10 for re-use in the emulsion. Such a monomer recovery and recycle system is not required for the present process, but may increase the efficiency of monomer utilization and help to reduce cost.

Irradiated base film 2 may exposed to the emulsion by known methods, as mentioned previously. For example, grafting chamber 8 may comprise an emulsion bath or a spray booth. Where a porous base film is employed, it may be immersed in an emulsion bath to imbibe the emulsion into the interior, and then sprayed with the emulsion, as well.

Where an emulsion bath is employed, means for agitating the emulsion may be employed, if desired. Conventional means for agitating the emulsion include stirring, sparging and ultrasonicating. Agitating may assist in maintaining the homogeneity of the emulsion.

Graft copolymer membrane 2 is then supplied to wash station 18 where it is washed in a suitable solvent. Solvent is provided to wash station 18 from solvent supply 20. Waste material may be separated from the solvent in separator 22 and the solvent recycled, as illustrated. Graft copolymer membrane 2 is then supplied to sulfonation chamber 24 and sulfonated therein.

As with the monomer recovery and recycle system discussed above, the illustrated solvent recycle system described in FIG. 1 is not required for the present process, but may increase the efficiency of solvent utilization in the graft polymerization process and help to reduce the cost and/or reduce the environmental impact of process waste streams.

In the illustrated embodiment, graft copolymer membrane 2 is sulfonated by sulfur trioxide vapor. If desired, graft copolymer membrane 2 could be sulfonated at elevated pressure and/or temperature to enhance the rate of sulfonation. The sulfur trioxide may be diluted with an inert gas, such as nitrogen, to reduce its activity, as well. If desired, graft copolymer membrane 2 could be pre-soaked in a solvent to swell it, thereby facilitating sulfonation of the interior of the membrane. Suitable solvents include halogenated solvents such as 1,2-dichloroethane and 1,1,2,2-tetrachloroethane, for example. However, other sulfonation reagents and/or conditions may be employed in the present process, as discussed above.

Of course, other ion exchange functionality could be introduced into graft copolymer membrane 2, such as those discussed above.

Sulfonated membrane 2 is then directed to water wash station 26. The wash water is recovered and recycled and waste is collected in vessel 28 for disposal, as illustrated.

Sulfonated membrane 2 is then dried in station 30 before being collected at roller station 32.

### EXAMPLE 1

### Emulsion Graft Polymerization of para-methyl-α,β,β-trifluorostyrene (p-Me-TFS) to Polyvinylidene Fluoride (Tedlar® SP) Film

Four samples of 25 μm thick polyvinylidene fluoride (Tedlar® SP) film (7 cm×7 cm) were irradiated with a dose of 20 Mrad using a 10 MeV ion beam radiation source, in an inert atmosphere with dry ice cooling. A 30% (v/v) emulsion was prepared by adding neat, degassed p-Me-TFS and dodecylamine hydrochloride to water (DDA.HCl; 0.050 g/ml water). Two irradiated base film samples were then immersed in the emulsion at 80° C. for 2-3 hours, in an inert atmosphere. The other two samples were exposed to neat, degassed p-Me-TFS under the same reaction conditions. The p-Me-TFS grafted films were then washed twice with acetone and once with toluene before being dried at 45° C. in a vacuum (3.9 kPa) for 3 hours. The percentage graft polymerization for each sample was then determined by calculating the percentage increase in mass of the grafted film relative to the mass of the base film.

The reaction conditions and percentage graft polymerization for each sample is summarized in Table 1.

TABLE 1
Emulsion graft polymerization of p-Me-TFS to
polyvinylidene fluoride film

| | Emulsion or | | |
|---|---|---|---|
| Sample | Neat | Time (h) | % Graft |
| 1 | neat | 2 | 71.8 |
| 2 | emulsion | 2 | 93.5 |
| 3 | neat | 3 | 77.6 |
| 4 | emulsion | 3 | 104 |

### EXAMPLE 2

### Emulsion Graft Polymerization of p-Me-TFS to poly(ethylene-co-chlorotrifluoroethylene) (Halar®) Film

7 cm×7 cm samples of poly(ethylene-co-chlorotrifluoroethylene) (Halar®) film were prepared from 25 μm and 50 μm thick Halar® 300LC and Halar® MBF (porous film; 630 μm thick, 204 g/m²). The samples were irradiated with a dose of 10-40 Mrad using a 10 MeV ion beam radiation source. Samples 5-20 were irradiated in an inert atmosphere with dry ice cooling. An emulsion was prepared as described in Example 1. Half the samples were then immersed in the emulsion at 60-80° C. for 24 hours, in an inert atmosphere. The remaining half of the samples were exposed to neat, degassed p-Me-TFS under the same reaction conditions. The p-Me-TFS grafted films were then washed twice with acetone and once with toluene before being dried at 45° C. in a vacuum (3.9 kPa) for 3 hours. The percentage graft polymerization for each sample was then determined as described in Example 1.

The reaction conditions and percentage graft polymerization for each is summarized in Table 2.

TABLE 2
Emulsion graft polymerization of p-Me-TFS to
poly(ethylene-co-chlorotrifluoroethylene) film

| | Dense/ | Thickness | Dose | Emulsion | Temperature | % |
|---|---|---|---|---|---|---|
| Sample | Porous | (μm) | (Mrad) | or Neat | (° C.) | Graft |
| 5 | dense | 25 | 10 | neat | 60 | 48.0 |
| 6 | dense | 25 | 10 | emulsion | 60 | 80.8 |
| 7 | dense | 25 | 20 | neat | 60 | 58.5 |
| 8 | dense | 25 | 20 | emulsion | 60 | 88.6 |
| 9 | dense | 25 | 40 | neat | 60 | 62.1 |
| 10 | dense | 25 | 40 | emulsion | 60 | 105 |
| 11 | dense | 25 | 10 | neat | 70 | 44.9 |
| 12 | dense | 25 | 10 | emulsion | 70 | 64.9 |
| 13 | dense | 25 | 20 | neat | 70 | 50.6 |
| 14 | dense | 25 | 20 | emulsion | 70 | 88.7 |
| 15 | dense | 25 | 10 | neat | 80 | 19.6 |
| 16 | dense | 25 | 10 | emulsion | 80 | 56.8 |
| 17 | dense | 50 | 20 | neat | 60 | 56.0 |
| 18 | dense | 50 | 20 | emulsion | 60 | 98.2 |
| 19 | porous | 630 | 20 | neat | 60 | 40.8 |
| 20 | porous | 630 | 20 | emulsion | 60 | 68.9 |

### EXAMPLE 3

### Emulsion Graft Polymerization of p-Me-TFS to poly(ethylene-co-tetrafluoroethylene) (Tefzel®) Film

Samples of 2 mil (approximately 50 μm) thick poly(ethylene-co-tetrafluoroethylene) (Tefzel®) film (7 cm×7 cm) were irradiated with a dose of 20 Mrad using a 10 MeV ion beam radiation source, in an inert atmosphere with dry ice cooling. Emulsions were prepared by adding neat, degassed p-Me-TFS and dodecylamine hydrochloride (DDA.HCl) to water at varying concentrations. Two irradiated base film samples were then immersed in a given emulsion at 80° C. for 2 hours, in an inert atmosphere. In addition, sample 53 was exposed to neat, degassed p-Me-TFS under the same reaction conditions. The p-Me-TFS grafted films were then washed twice with acetone and once with toluene before being dried at 45° C. in a vacuum (3.9 kPa) for 3 hours. The percentage graft polymerization for each sample was then determined as described in Example 1.

The reaction conditions, emulsion composition and percentage graft polymerization for each sample tested are summarized in Table 3.

TABLE 3
Emulsion graft polymerization of p-Me-TFS to
poly(ethylene-co-tetrafluoroethylene) film

| | | DDA.HCl | | |
|---|---|---|---|---|
| | % Monomer | concentration | | Average |
| Sample | (by weight) | (g/ml water) | % Graft | % Graft |
| 21 | 10 | 0.006 | 34.5 | 33.7 |
| 22 | 10 | 0.006 | 32.9 | |
| 23 | 30 | 0.006 | 47.7 | 48.2 |
| 24 | 30 | 0.006 | 48.7 | |
| 25 | 50 | 0.006 | 50.8 | 50.2 |
| 26 | 50 | 0.006 | 49.7 | |
| 27 | 70 | 0.006 | 51.5 | 51.4 |
| 28 | 70 | 0.006 | 51.3 | |
| 29 | 10 | 0.050 | 59.8 | 61.0 |
| 30 | 10 | 0.050 | 62.2 | |
| 31 | 30 | 0.050 | 59.9 | 58.6 |
| 32 | 30 | 0.050 | 57.3 | |
| 33 | 50 | 0.050 | 56.1 | 56.3 |
| 34 | 50 | 0.050 | 56.5 | |
| 35 | 70 | 0.050 | 52.5 | 52.2 |
| 36 | 70 | 0.050 | 51.8 | |
| 37 | 10 | 0.100 | 63.0 | 62.9 |
| 38 | 10 | 0.100 | 62.7 | |
| 39 | 30 | 0.100 | 58.5 | 58.2 |
| 40 | 30 | 0.100 | 57.9 | |
| 41 | 50 | 0.100 | 55.7 | 55.3 |
| 42 | 50 | 0.100 | 54.8 | |
| 43 | 70 | 0.100 | 51.3 | 51.2 |
| 44 | 70 | 0.100 | 51.1 | |
| 45 | 10 | 0.170 | 58.7 | 56.4 |
| 46 | 10 | 0.170 | 54.1 | |
| 47 | 30 | 0.170 | 54.0 | 54.7 |
| 48 | 30 | 0.170 | 55.4 | |
| 49 | 50 | 0.170 | 53.1 | 52.9 |
| 50 | 50 | 0.170 | 52.7 | |
| 51 | 70 | 0.170 | 49.4 | 49.0 |
| 52 | 70 | 0.170 | 48.6 | |
| 53 | 100 | — | 36.2 | 36.2 |
| | (neat) | | | |

As shown in Tables 1-3, with the exception of samples 21 and 22, the emulsion graft polymerized samples exhibited higher graft polymerization rates relative to the comparative examples using the neat monomer under otherwise identical reaction conditions. Thus, the present process can achieve higher graft polymerization rates using less monomer than can be achieved when employing neat monomer under similar reaction conditions.

Also note that, with the exception of samples 21-28, there is a trend of increasing percentage graft polymerization with lower concentration of the monomer in the emulsion (see Table 3). Indeed, the highest percentage grafts for samples 29-52 were achieved using an emulsion having 10% monomer. This result for the emulsion graft polymerization process is surprising, since graft polymerization using TFS in solution yields lower percentage grafts with decreasing monomer concentration.

### EXAMPLE 4

### Emulsion Graft Polymerization of p-Me-TFS to poly(ethylene-co-chlorotrifluoroethylene) (Halar®) Film

5 cm×5 cm samples of poly(ethylene-co-chlorotrifluoroethylene) (Halar® 300LC; 25 μm thick) film were irradiated with a dose of 20 Mrad using a 10 MeV ion beam radiation source, in an inert atmosphere with dry ice cooling. Emulsions were prepared by adding neat, degassed p-Me-TFS, at varying concentrations, to aqueous solutions of Triton® X-100. Irradiated base film samples were then immersed in a given emulsion at 60° C. for 2 hours, in an inert atmosphere. In addition, sample 74 was exposed to neat, degassed p-Me-TFS under the same reaction conditions. The p-Me-TFS grafted films were then washed twice with acetone and toluene before being dried at 70° C. in a vacuum (3.9 kPa) for 3 hours. The percentage graft polymerization for each sample was then determined as described in Example 1.

The reaction conditions and percentage graft polymerization for each sample is summarized in Table 4.

TABLE 4
Emulsion graft polymerization of p-Me-TFS to
poly(ethylene-co-chlorotrifluoroethylene) film

| | % Monomer | % Triton ® X-100 | |
|---|---|---|---|
| Sample | (by weight) | (by weight)* | % Graft |
| 54 | 2.0 | 2.0 | 34 |
| 55 | 5.0 | 2.0 | 34 |
| 56 | 10 | 2.0 | 32 |
| 57 | 20 | 2.0 | 34 |
| 58 | 30 | 2.0 | 34 |
| 59 | 2.0 | 5.0 | 26 |
| 60 | 5.0 | 5.0 | 31 |
| 61 | 10 | 5.0 | 33 |
| 62 | 20 | 5.0 | 32 |
| 63 | 30 | 5.0 | 32 |
| 64 | 2.0 | 10 | 15 |
| 65 | 5.0 | 10 | 37 |
| 66 | 10 | 10 | 34 |
| 67 | 20 | 10 | 32 |
| 68 | 30 | 10 | 32 |
| 69 | 2.0 | 30 | 2.1 |
| 70 | 5.0 | 30 | 7.9 |
| 71 | 10 | 30 | 31 |
| 72 | 20 | 30 | 29 |
| 73 | 30 | 30 | 26 |
| 74 | 100 | — | 18 |
| | (neat) | | |

*The concentration of Triton ® X-100 in solution before the addition of monomer.

As shown in Table 4, for initial concentrations of emulsifier 10% or less, the emulsion graft polymerized samples generally exhibited higher graft polymerization rates relative to the sample using the neat monomer under otherwise identical reaction conditions. Indeed, high graft polymerization rates were demonstrated for emulsions having only 2-5% monomer (samples 54, 55, 59 and 60). Table 4 also demonstrates that the graft polymerization rate for emulsions employing 2-5% Triton® X-100 is relatively insensitive to the concentration of monomer. In addition, the emulsions prepared with the nonionic emulsifier were more stable than the emulsions prepared with DDA.HCl.

### EXAMPLE 5

### Sulfonation of poly(ethylene-co-tetrafluoroethylene)-g-p-Me-TFS

Samples 29 and 30 of Example 3 were sulfonated as follows. Each sample was immersed in a sulfonation solution (30% SO₃ in dichloroethane, with 5% w/w acetic acid) for 2 hr at 50° C. The EW of the sulfonated samples was determined, as was the amount of water present in the samples. From this data the percentage sulfonation of the samples was determined. Percentage sulfonation is measured as the percentage of available sites on the graft copolymer that are sulfonated, assuming one sulfonate group per site. The sulfonation results are summarized in Table 5.

TABLE 5
Sulfonation of poly(ethylene-co-tetrafluoroethylene)-g-p-Me-TFS

| | | | Water content | |
|---|---|---|---|---|
| Sample | % Graft | EW (g/mol) | (wt. %) | % Sulfonation |
| 29 | 59.8 | 591 | 35.3 | 94.1 |
| 30 | 62.2 | 574 | 37.7 | 95.1 |

The present process provides for the preparation of graft copolymer membranes from fluorostyrenic monomers that is straightforward and makes efficient use of the monomers. The ability to use lower concentrations of monomer than is currently employed in solution or emulsion graft polymerization of fluorostyrenic monomers, while achieved comparable or superior graft polymerization rates, allows for considerable cost savings in membrane production, particularly in high-volume, continuous production.

All of the above U.S. patents, U.S. patent application publications, U.S. patent applications, foreign patents, foreign patent applications and non-patent publications referred to in this specification and/or listed in the Application Data Sheet, are incorporated herein by reference in their entirety.

While particular elements, embodiments and applications of the present invention have been shown and described, it will be understood, of course, that the invention is not limited thereto since modifications may be made by those skilled in the art, particularly in light of the foregoing teachings. It is therefore contemplated by the appended claims to cover such modifications that incorporate those features coming within the scope of the invention.

1. A process for preparing a graft copolymer membrane, the process comprising:
exposing a polymeric base film to a dose of ionizing radiation; and
contacting the irradiated base film with an emulsion comprising at least one substituted fluorostyrenic monomer,
wherein the amount of monomer in the emulsion is less than or equal to 30% by volume.

2. The process of claim 1 wherein at least one of steps (a) and (b) are performed in an inert atmosphere.

3. The process of claim 1 wherein the base film comprises a fluorinated polymer.

4. The process of claim 1 wherein the base film comprises a polymer selected from the group consisting of polyvinylidene fluoride, poly(tetrafluoroethylene-co-perfluorovinylether), poly(tetrafluoroethylene-co-hexafluoropropylene), poly(ethylene-co-chlorotrifluoroethylene), polyethylene, polypropylene, poly(ethylene-co-tetrafluoroethylene), poly(vinylidene fluoride-co-hexafluoropropylene), poly(vinylidene fluoride-co-chlorotrifluoroethylene), and polytetrafluoroethylene.

5. The process of claim 1 wherein the base film comprises polyvinylidene fluoride.

6. The process of claim 1 wherein the base film comprises poly(ethylene-co-chlorotrifluoroethylene).

7. The process of claim 1 wherein the base film comprises ultra-high molecular weight polyethylene.

8. The process of claim 1 wherein the dose of ionizing radiation is in the range of about 1 Mrad to about 100 Mrad.

9. The process of claim 1 wherein the dose of ionizing radiation is in the range of about 20 Mrad to about 60 Mrad.

10. The process of claim 1 wherein the emulsion is an aqueous emulsion.

11. The process of claim 1 wherein the emulsion further comprises a solvent that aids in swelling of the base film.

12. The process of claim 1 wherein the at least one substituted fluorostyrenic monomer comprises a substituted α,β,β-trifluorostyrene.

13. The process of claim 1 wherein the at least one substituted fluorostyrenic monomer is selected from the group consisting of methyl-α,β,β-trifluorostyrenes, methoxy-α,β,β-trifluorostyrenes, thiomethyl-α,β,β-trifluorostyrenes, phenyl-α,β,β-trifluorostyrenes, and mixtures thereof.

14. The process of claim 1 wherein the at least one substituted fluorostyrenic monomer comprises para-methyl-α,β,β-trifluorostyrene.

15. The process of claim 1 wherein the at least one substituted fluorostyrenic monomer is selected from the group consisting of substituted α-fluorostyrenes, α,β-difluorostyrenes, and α,β,β-trifluorostyrenes, and mixtures thereof.

16. The process of claim 1 wherein the emulsion further comprises at least one monomer selected from the group consisting of styrene, α-methylstyrene and vinyl phosphonic acid.

17. The process of claim 1 wherein the emulsion further comprises an emulsifier.

18. The process of claim 17 wherein the emulsifier comprises dodecylamine hydrochloride or sodium lauryl sulfate.

19. The process of claim 17 wherein the emulsifier comprises a nonionic emulsifier.

20. The process of claim 17 wherein the emulsifier comprises a polyoxyethylene emulsifier.

21. The process of claim 17 wherein the emulsifier comprises an alkylphenolhydroxypolyoxyethylene.

22. The process of claim 1 wherein the emulsion further comprises an inhibitor.

23. The process of claim 1 wherein the irradiated base film is contacted with the emulsion at a temperature of about 20° C. to about 100° C.

24. The process of claim 1 wherein the irradiated base film is contacted with the emulsion at a temperature of about 50° C. to about 80° C.

25. The process of claim 1 wherein the irradiated base film is sprayed with the emulsion.

26. (canceled)

27. The process of claim 1, further comprising introducing ion exchange functionality into the graft copolymer membrane.

28. The process of claim 27, further comprising treating the graft copolymer membrane by a reaction selected from the group consisting of halomethylation, sulfonation, phosphonation, amination, carboxylation, hydroxylation and nitration.

29. The process of claim 1, further comprising sulfonating or phosphonating the graft copolymer membrane.

30. The process of claim 1, further comprising sulfonating the graft copolymer membrane by swelling the graft copolymer membrane in a halogenated solvent and exposing the swollen membrane to sulfur trioxide vapour.

31-49. (canceled)

50. The process of claim 1 wherein the amount of monomer in the emulsion is less than or equal to 20% by volume.

51. The process of claim 1 wherein the amount of monomer in the emulsion is less than or equal to 10% by volume.

52. The process of claim 1 wherein the amount of monomer in the emulsion is less than or equal to 5% by volume.

53. The process of claim 1 wherein the amount of monomer in the emulsion is less than or equal to 2% by volume.

54. The process of claim 1 wherein the amount of monomer in the emulsion ranges from 2-5% by volume.

55. The process of claim 1 wherein the amount of monomer in the emulsion is 10% by volume.
